(19) United States
(12) Patent Application Publication
(10) Pub. No.: US 2005/0093260 A1
(43) Pub. Date: May 5, 2005

(54) Non co-planar rear suspension for heavy trucks

(76) Inventor: William Bernard Trescott, Bay City, TX (US)

Correspondence Address: William B. Trescott, 8028 HWY 457, Bay City, TX, 77414, US

(21) Appl. No.: 10/696,765

(22) Filed: Oct. 30, 2003

(51) Int. Cl. B60G 7/02; B60G 3/12

(52) U.S. Cl. 280/86.5; 280/124.128; 280/86.75; 280/5.507

(57) ABSTRACT

A non co-planar trailing beam or walking beam variable height suspension which allows vehicles to lower cargo bodies onto the ground as well as use conventional loading docks. The toe angle changes as the vehicle height changes to compensate for bending forces applied to trailing and walking beams during high speed turns.

### FIELD OF THE INVENTION

The present invention relates to suspension systems for vehicles. More particularly, to independent rear suspensions for heavy trucks.

### BACKGROUND OF THE INVENTION

Vehicles and trucks of various kinds are widely available for transporting goods. Trucks for carrying large loads in enclosed cargo bodies are generally quite tall and, consequently, unstable. It is an object of the present invention, therefore, to provide a means for transporting goods in vehicles which present a relatively low, wide, and stable configuration.

Further, it is known to load trucks by backing them against buildings. Loading docks, cranes, and special lifting apparatus have usually been necessary to transfer cargo on and off of trucks because truck cargo bodies and cargo decks are raised high above the ground. It is a further object of the present invention to provide a vehicle with the capability to load and unload cargo on and off the ground without auxiliary mechanisms.

It is further known to equip vehicles with variable height trailing beam suspensions using stub axles as shown in U.S. Pat. No. 6,428,026 to Smith and steerable wheels as in U.S. Pat. No. 6,086,077 to Stuart. Such suspensions typically consist of multiple wheels and tires connected to a transversely mounted solid axle extending under the vehicle which is pivotally connected to the vehicle frame by one or more projecting arms known as trailing beams. Air bags or other types of springs are usually installed between the arms and the vehicle frame to cushion the ride, resulting in a vehicle which is quite tall. As taught by Stuart, one of the problems with air spring suspensions is that the air springs in and of themselves do not provide any lateral support as does a conventional leaf spring suspension which can be attached to the chassis in multiple places by a plurality of shackles. To provide lateral support for air springs, most manufacturers include a lateral control rod called a tracking bar or tracking rod, such as shown in U.S. Pat. No. 6,056,305 to Pribyl, which is typically attached to a sprung component at one end such as the axle and to an unsprung component at the other end, such as a frame rail of the vehicle chassis. While tracking rods provide lateral support, there are three drawbacks to their use in a vehicle—they add weight, they prevent the cargo body from being lowered onto the ground, and the tracking arm will swing through an arc inducing some lateral displacement of the axle relative to the chassis. This third effect can cause the vehicle to exhibit yaw and other undesirable handling characteristics.

### STATEMENT OF THE PROBLEM

When a vehicle with four or more wheels mounted on springs travels around a highway curve at high speed, centrifugal force causes the weight of the vehicle to shift from the wheels on the inside of the curve to the wheels on the outside. The weight on the outside tires can be as much as double the weight they carry at rest. Further, the vehicle leans so that the springs on the outside are compressed while the springs on the inside of the turn are relaxed, causing the cargo body to tilt, possibly inducing the load to shift. Unless the axles are equipped with tracking rods, or an equivalent auxiliary mechanical device such as the bell cranks taught by Stuart to prevent lateral movement of the axle relative to the frame of the vehicle, the centrifugal force on the overloaded outside wheels combined with gyroscopic torque from the rotating wheel will cause the arms or trailing beams to bend so that the wheel alignment of the axle will change from neutral wheel alignment to toe out wheel alignment and the vehicle will veer sideways off the road. Adding reinforcing material to the arms or vehicle frame to resist such bending forces adds weight to the vehicle, reducing its cargo capacity, fuel economy, and ride quality. It is desired to provide a vehicle suspension which can compensate for the excessive bending of lightweight flexible materials, such as fiberglass, without resorting to the use of tracking rods, bell cranks, or other auxiliary mechanical devices.

### SOLUTION TO THE PROBLEM AND SUMMARY OF THE INVENTION

The Non Co-planar Suspension of my invention comprises at least one wheel or tire mounted on an axle connected by at least one arm or beam to a vehicle frame by pivots which are non-coplanar with the axle. The axle can be mounted on one beam or arm like an aircraft landing gear, or two beams or arms like the rear wheel of a bicycle or motorcycle. Regardless of the number of beams or arms, the angle of the pivot or pivots where the beams are attached to the frame of the vehicle is not level with the ground. The pivot is angled so that one end of the pivot is higher than the other so that when the vehicle's height above the ground changes, the toe angle of the axle also changes. Therefore, when centrifugal force or gyroscopic torque causes the trailing beam or vehicle frame to bend, thus changing the toe angle and position of the axle, the change in the vehicle's height above the ground will also cause the toe angle and axle position to change in the opposite direction, counteracting the changes caused by external forces.

### BRIEF DESCRIPTION OF THE FIGURES

FIG. 1 is a perspective view of a vehicle having three non co-planar trailing beam rear wheel assemblies according to the present invention on each side of a cargo body.

FIG. 2 is a perspective view of a vehicle with the cargo body removed to reveal two non co-planar rear wheel assemblies according to the present invention on each side of the vehicle in walking beam configuration.

FIG. 3 is a perspective view of a rear wheel assembly according to the present invention.

FIG. 4 is a front plan view of the wheel assembly of FIG. 3.

FIG. 5 is a side plan view of a simplified rear wheel assembly supporting a vehicle at a medium height above the ground.

FIG. 6 is a top plan view of the wheel assembly of FIG. 5.

FIG. 7 is a side plan view of the simplified rear wheel assembly of FIG. 5 supporting a vehicle at an elevated height above the ground

FIG. 8 is a top plan view of the wheel assembly of FIG. 7.

FIG. 9 is a side plan view of the simplified rear wheel assembly of FIG. 5 supporting a vehicle at a reduced height above the ground.

FIG. 10 is a top plan view of the wheel assembly of FIG. 9.

FIG. 11 is a plan view of a wheel assembly in extended position.

### DETAILED DESCRIPTION

I will now describe the preferred embodiment of my invention with reference to the accompanying drawings, wherein like numerals are used to refer to like parts.

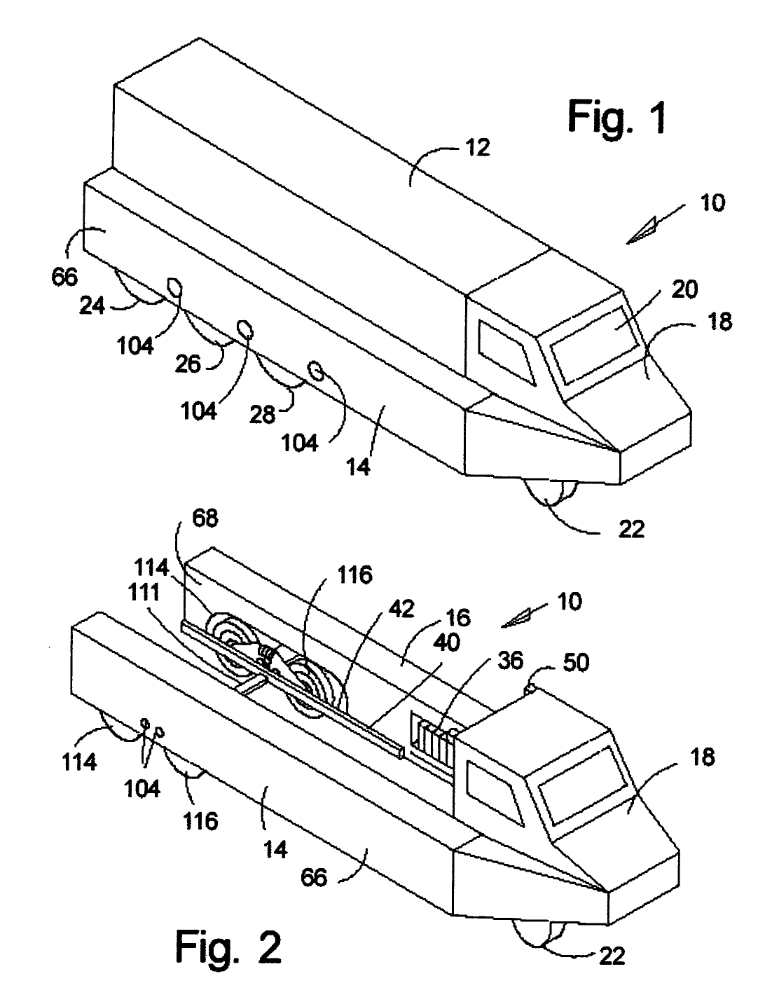

FIG. 1 and FIG. 2 show perspective views of two alternate arrangements of a vehicle 10 according to my invention. In FIG. 1, all rear axles 24, 26, 28 according to my invention are in trailing beam configuration, which is preferred to achieve the best possible ride quality. In FIG. 2, the rear axles 114, 116 according to my invention are in walking beam configuration, which is preferred to neutralize forces and minimize weight.

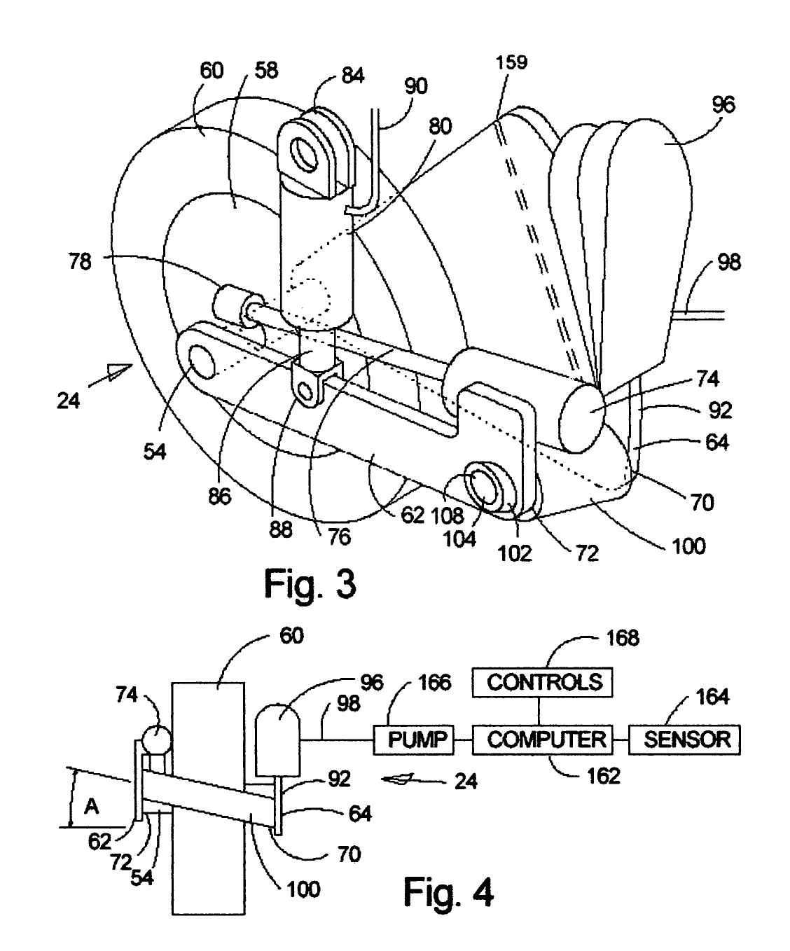

In both arrangements, the vehicle 10 supports the cargo body 12 on two parallel frames 14, 16. The frames extend rearwardly from a cab 18. The cab 18 comprises an operator's compartment where control apparatus (not shown) for an operator are located. The cab 18 has steerable wheels 22, controlled by the operator, and other standard features well known in the art. The vehicle may be powered by various means, such as by diesel or gasoline engines, by front or rear wheel drives, or by other well known means. In both arrangements, a Diesel-electric or turbo-electric may be used. Rear wheel assemblies 24, 26, 28, 114, 116 may be equipped with either direct electric drive, electric drive with planetary reduction, worm drive or ring and pinion gear drive (see FIG. 3). Batteries 36 for regenerative braking may be installed Preferably, the frames 14, 16 comprise generally rectangular fiber glass crash absorbent conduits with steel framing 40 supporting the rear wheels. In FIG. 2, the rear wheels 114, 116 are shown through the conduit for viewing. Preferably, however, the conduit would cover the wheels for strength.

A rear wheel assembly 24 according to my invention is shown in perspective view in FIG. 3 as it might appear on the right rear wheel positions 24, 114 of the vehicle 10 in FIG. 1 and FIG. 2 or the left middle wheel position 116 of the vehicle 10 in FIG. 2. The wheel assembly 24 comprises an axle 54 supporting a wheel 56 comprising a hub 58 and a removable pneumatic tire 60. Certain conventional features such as brakes and mounting bolts are not shown. The axle is supported by an outer arm 62 and an inner arm 64. The inner arm 64 is attached to the support frame 40 at a first pivot 70. The outer arm 62 is attached to the support frame 40 at a second pivot 72. In both preferred embodiments, an electric drive motor 74 is mounted on the outer arm 62. A drive shaft 76 couples the motor 74 to a gear 78 that turns the wheel 56. A hydraulic actuator 80 may be provided as a means for controlling the orientation and motion of the outer arm 62. The actuator 80 has cylinder 82 with a coupling 84 for connection to the frame and a piston 86 with a coupling 88 connected to the outer arm 62. A control line 90 conducts fluid to and from the cylinder 82 to control the extension of the actuator 80 in a known manner.

It will be apparent that in this configuration, the wheel 56 is removed from its axle towards the inside of the vehicle 10, as will be explained more fully below. The inner arm 64, therefore, is configured as a generally flat triangular suspension hanger 92 that can be removed to service the wheel or provided with a piano hinge 159 so it can be pivoted to the side to service the wheel. An air bellows 96 is attached to the suspension hanger 92. Together with the hydraulic actuator 80, the air bellows controls the orientation of the wheel through the inner arm 64. An air line 98 provides air as a control fluid for expanding or contracting the bellows. Pneumatically controlled air bags are preferred because they provide a large range of expansion at relatively low cost, but other control means could also be used.

The first pivot 70 and the second pivot 72 may be connected by, for example, a sleeve 100. The arms may be rigidly connected to the sleeve 100, and the pivots may be provided by the sleeve turning around an inner cylinder 102. A lubricant or other friction-reducing means would be provided between the inner cylinder and the sleeve. A cooling duct 104 extends through the inner cylinder. Preferably each cooling duct has an inlet 106 opening through the inner wall 68 of a frame and on outlet 108 extending through the outer wall 66 of a frame. Air flows through the cooling duct 104 to cool the lubricant between the inner cylinder 102 and the sleeve 100.

An important feature of the wheel assembly 24 can be seen in FIG. 4, a plan view of the rear wheel assembly. The axle 54 is horizontal, while the sleeve 100 rises from the first pivot 70 to the second pivot 72. The second pivot is higher than the first pivot. Thus the axle and the two pivots (or the axle and the sleeve or inner cylinder) are non-coplanar, that is, if these elements were represented by a line and two points (or by two lines), they would not be contained in a single plane. A line between the first and second pivots is raised from the horizontal by an angle A. The angle A is preferably between 0.5 and 10 degrees, more preferably between 1 and 6 degrees and most preferably between 2 and 3 degrees, depending on the resistance of the arms and other structural members of the vehicle to bending. The effect of the non-planar axle and pivot points is represented in FIGS. 5 through 10. In these figures a wheel assembly is represented in a simplified fashion for clarity. The inner arm 64 is represented as a linear element, as is the outer arm 62, and only the inner cylinder 102 is shown, and elements such as the sleeve, motor and bellows are omitted. It will be understood, however, that such elements may be used as described above.

FIG. 5 represents the wheel assembly 24 in a neutral position. The inner arm 64 slants upwardly from the first pivot 70 to the axle 54, while the outer arm 62 slants downwardly from the second pivot 72 to the axle. The vehicle 10 is at a drive height, as represented by a lower edge 110 of a vehicle frame such as frame 14 or frame 16. As shown in the top view of FIG. 6, this orients the axle parallel to the inner cylinder 102 and the wheel 56 is co-linear with the vehicle frame.

When the arms 62, 64 are forced down by the action of the actuator 80 and the air bellows 96 (not shown in these views), the vehicle 10 is elevated, as shown by the position of the lower edge 110 in FIG. 7. At the same time, the axle 54 is no longer perpendicular to the long axis of the vehicle frame, and the toe angle of the wheel 56 changes shown in FIG. 8.

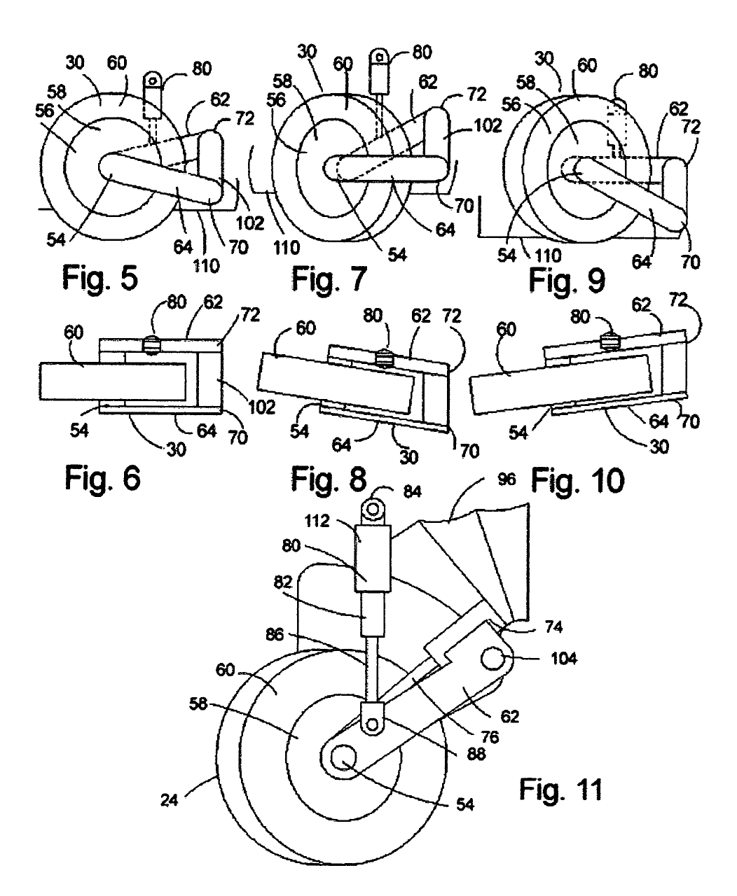

When arms 62, 64 are forced up, as shown in FIG. 9, the bottom edge 110 of the vehicle frame lowers to near or at the road surface, as shown in FIG. 9. The axle 54 pivots and the toe angle of wheel 56 changes as shown in FIG. 10.

It is preferred to mount the wheels 56 as close as possible to the sides of the cargo body thereby minimizing the bending torque on the vehicle frame caused by the cargo body and its load not being directly over the wheels. For this reason, and also to provide improved cooling of brakes and drivetrain components, the electric motors are placed on the outside of the wheels and the wheels are adapted to be changed from the inside of the beams, when the vehicle is raised to a height sufficient to access retaining bolts below the bottom edge of the cargo body 42. This condition is illustrated in FIG. 11. It will be understood that the drive motors could be mounted inside the wheels to facilitate tire changes and to provide a wider track width for improved vehicle stability, but many older roads and highways may not be wide enough to accommodate the wider track width unless the cargo body is made narrower.

The bellows 96 can be provided with sufficient expansion to extend the wheel to raise the cargo body to sufficient height to use normal truck loading docks or even to help unload conventional high profile trucks when a loading dock is unavailable by transferring cargo from one truck to another. A hydraulic actuator 80 of sufficient length would be very expensive. In addition to the active cylinder 82, and the piston 86, the actuator 80 also has a passive cylinder 112, in which the active cylinder slides. As the wheel is lowered and the vehicle is raised, the actuator 80 essentially disengages, and all of the weight of the vehicle beams is borne by the air bellows 96. Since this feature is used only at low speeds, the bellows can raise the vehicle in this manner. One skilled in the art will recognize that a swing arm (not shown) could also be used to connect the top of the hydraulic actuator 80 to the frame in lieu of the passive cylinder 112 to align the actuator with the vehicle frame after being disengaged.

As shown in FIG. 2, vehicles with two rear axles can have an opposed or “walking beam” suspension. This variation consists of a “leading beam” which is a trailing beam turned around backwards so that the support axle points forward instead of to the rear. With a first set of pivot points 70, 72 in the rear of a “leading beam” wheel assembly abuts a second set of pivot points 70, 72 of a “trailing beam” wheel assembly immediately behind them, suspension actuators such as the air bellows 96 can be horizontally mounted between right angle suspension hangers attached to the sleeve 100 (as in a mountain bike suspension) to offer some structural advantages such as neutralizing the forces of the tandem rear axle to lighten the structure.

If the pivots closer to the outside of the vehicle 72 are higher than the pivots near the inside of the vehicle 70, the vehicle can compensate for the bending of its trailing and walking beams caused by centrifugal force during turns by having a computer 162 coupled to an accelerometer or other suitable sensor 164 controlling the suspension height to lean the vehicle into the turn, banking like an aircraft. The computer 162 controls apparatus such as a pump 168 connected through the air line 98 to the bellows or a fluid pump coupled to the hydraulic actuator 80. Manual controls 168 in the cab are also connected to the computer 162 to control the height of the wheel assemblies for raising or lowering the vehicle when loading or unloading. The computer can also be programmed to lean the vehicle to the outside of the turn to reduce turning radius in close quarters when the steering wheel is turned all the way to the lock. In this configuration, leaning the vehicle to the outside of the turn has an effect of steering with the rear wheels. Those vehicles with walking beam suspensions will experience less tire scrub during tight turns when the vehicle is leaned in this way. For this reason, a walking beam arrangement as shown in FIG. 2 is preferred for primarily low speed operation. An all trailing beam arrangement as shown in FIG. 1 is preferred for primarily high speed operation because trailing beam suspensions generally provide a smoother ride quality than walking beam suspensions. A quad-axle vehicle (three rear wheel assemblies) might have a combination of a pair of wheel assemblies in walking-beam configuration 114, 116 combined with an additional trailing beam wheel assembly 24. It will be understood that variation in the heights of the wheels caused by driving hazards and road conditions will cause the wheels to toe in and out during driving. When the all trailing beam arrangement is used, this has a beneficial effect of compensating for sway, a problem in high profile vehicles, at the expense of increased tire wear.

Another arrangement offering lower cost and less complexity is to equip the vehicle with pivots 72 angled lower to the ground on the outside of the vehicle than pivots 70 on the inside. In this configuration, a computer is not needed and the natural lean of the vehicle to the outside during high speed turns will neutralize the toe angle to compensate for the flexing of the trailing beams. However, the leaning of the vehicle in this way can cause cargo inside the vehicle to shift position or possibly fall over, so this configuration is less preferred, but may be more than adequate in bulk cargo applications where preventing cargo damage is not a priority. Because this embodiment increases sway, rather than compensating for it, only the walking beam configuration should be used with this less preferred embodiment. A dump valve connected to the steering gear can reduce air or hydraulic pressure on those wheels on the inside of the turn to bank the vehicle into the turn like an aircraft. This action will reduce tire scrub in this configuration in much the same way as leaning the vehicle to the outside of the turn reduces tire scrub in the preferred embodiment which includes computer control. One skilled in the art will recognize that other methods for providing controls may be selected without departing from the teachings of this invention.

Although I have now described my invention in connection with my preferred embodiment, those skilled in the art will recognize that my invention may take other forms without departing from the spirit or teachings thereof. The foregoing description is intended, therefore, to be illustrative and not restrictive, and the scope of my invention is to be defined by the following claims:

1. A heavy truck rear suspension consisting of a wheel axle,
said wheel axle being supported by an arm,
said arm being connected to a vehicle frame by a first pivot,
said first pivot being connected to a second pivot,
said second pivot being connected to said vehicle frame on a common axis with said first pivot,
said axle, said first pivot, and said second pivot being non-coplanar.

2. The heavy truck rear suspension of claim 1 wherein said second pivot is higher than said first pivot.

3. The heavy truck rear suspension of claim 1 wherein said second pivot is lower than said first pivot.

4. The heavy truck rear suspension of claim 6 wherein said common axis connecting said first and second pivots deviates from horizontal by an angle of between 0.5 and 10 degrees.

5. The heavy truck rear suspension of claim 4 wherein said angle is between 1 and 6 degrees.

6. The heavy truck rear suspension of claim 5 wherein said angle is between about 2 and 3 degrees.

7. The heavy truck rear suspension of claim 1 wherein said first and second pivots are connected by a support axle.

8. The heavy truck rear suspension of claim 7 wherein said arm is rigidly connected to said support axle and said support axle is pivotally connected to said vehicle frame

9. The heavy truck rear suspension of claim 8 wherein said support axle comprises an inner cylinder connected between said first pivot and said second pivot, said cylinder having an air flow passage opening through said vehicle frame, and a sleeve rotatably mounted around said inner cylinder, said arm being rigidly connected to said sleeve.

10. The heavy truck rear suspension of claim 8 further comprising a hydraulic cylinder coupled between said arm and said vehicle frame, said hydraulic cylinder raising and lowering said vehicle frame with respect to said wheel axle and simultaneously causing said wheel axle to pivot with respect to said vehicle frame.

11. The heavy truck rear suspension of claim 8 further comprising an air bellows connected between said support axle and said vehicle frame, said air bellows raising and lowering said heavy truck rear frame with respect to said wheel axle and simultaneously causing said wheel axle to pivot with respect to said vehicle frame.

12. The heavy truck rear suspension of claim 1 wherein said heavy truck rear suspension further comprises at least one motor coupled to said wheel axle.

13. The heavy truck rear suspension of claim 1 wherein said vehicle frame further comprises an inner wall and an outer wall and said wheel axle is mounted between said inner and outer walls being supported by an inner arm and an outer arm, said inner arm being connected to said first pivot, said first pivot being connected to said inner wall of said vehicle frame, said outer arm being connected to said second pivot, said second pivot being connected to said outer wall of said vehicle frame.

14. The heavy truck rear suspension of claim 13 wherein said first and second pivots are connected by a support axle and said first arm and said second arm are rigidly connected to said support axle and said support axle is pivotally connected to said vehicle frame

15. The heavy truck rear suspension of claim 13 further comprising a hydraulic cylinder coupled between at least one of said first and second arms and said vehicle frame, said hydraulic cylinder raising and lowering said vehicle frame with respect said wheel and simultaneously causing said wheel to pivot with respect to said vehicle frame.

16. The heavy truck rear suspension of claim 13 further comprising an air bellows connected between at least one of said first and second arms and said vehicle frame, said air bellows raising and lowering said vehicle frame with respect to said wheel axle and simultaneously causing said wheel axle to pivot with respect to said vehicle frame.

17. The heavy truck rear suspension of claim 14 wherein said support axle comprises an inner cylinder connected between said first pivot and said second pivot, said cylinder having an air flow passage opening through said vehicle frame, and a sleeve rotatably mounted around said inner cylinder, said first and second arms being rigidly connected to said sleeve.

18. The heavy truck rear suspension of claim 1 further comprising means for pivoting said wheel, control means for automatically controlling said pivoting means and a sensor coupled to said control means, said sensor producing a signal representative of motion of said vehicle, said control means responsive to said sensor.
